(19) United States
(12) Patent Application Publication
(10) Pub. No.: US 2016/0223117 A1
(43) Pub. Date: Aug. 4, 2016

(54) CONDUIT HAVING INTEGRAL, MONOLITHIC FLOW REGULATION FEATURES

(71) Applicant: General Electric Company, Schenectady, NY (US)

(72) Inventor: Joel Erik Hitzelberger, Louisville, KY (US)

(21) Appl. No.: 14/608,474

(22) Filed: Jan. 29, 2015

(51) Int. Cl. F16L 55/027

(52) U.S. Cl. CPC F16L 55/027; B33Y 80/00

(57) ABSTRACT

Conduits having improved flow modification features are provided. A conduit includes a body having an inner surface and an outer surface, the inner surface defining an interior. The conduit further includes a flow regulation assembly disposed within the interior. The flow regulation assembly includes an integral component that is monolithic with the body. The flow regulation assembly is configured to permit fluid flow through the interior past the flow regulation assembly in a first direction and restrict fluid flow through the interior past the flow regulation assembly in a second direction opposite to the first direction.

### FIELD OF THE INVENTION

The present disclosure relates generally to conduits, such as pipe sections, which may be utilized for flowing fluids therethrough. In particular, the present disclosure is directed to conduits which include integral and monolithic flow regulation features therein.

### BACKGROUND OF THE INVENTION

Conduits for flowing fluids therethrough, such as in appliances, plumbing applications, etc., are generally known. A plurality of conduits may be connected together by suitable connector components to form a flow path for the fluid. In appliance environments, conduits may be utilized for example as air ducts in refrigerators, or as drain lines in refrigerators, dishwashers, washing machines, etc.

In many cases, it is desirable for fluid flow through an appliance to be restricted in one direction, such that fluid cannot “backflow” through the conduits and flowpath defined thereby. Presently known solutions for facilitating such one-way flow are to couple one-way flow valves between adjacent conduits. These valves restrict the flow of fluid between the adjacent conduits in one direction, while allowing the flow of fluid between the adjacent conduits in an opposite direction.

However, this approach to facilitating one-way flow has a number of disadvantages. In particular, the number of separate components which are coupled together to provide one-way flow introduces a number of weak points in the assembly where leakage or assembly failure can occur. Additionally, because known one-way flow valves are separate components which must be coupled between adjacent conduits, the positioning of the valves relative to the conduits is limited.

Accordingly, improved apparatus for facilitating flow regulation through conduits is desired. In particular, flow regulation apparatus that allow for stronger resulting conduit assemblies and which allow increased positioning options would be advantageous.

### BRIEF DESCRIPTION OF THE INVENTION

Aspects and advantages of the invention will be set forth in part in the following description, or may be obvious from the description, or may be learned through practice of the invention.

In one embodiment, a conduit is provided. The conduit includes a body having an inner surface and an outer surface, the inner surface defining an interior. The conduit further includes a flow regulation assembly disposed within the interior. The flow regulation assembly includes an integral component that is monolithic with the body. The flow regulation assembly is configured to permit fluid flow through the interior past the flow regulation assembly in a first direction and restrict fluid flow through the interior past the flow regulation assembly in a second direction opposite to the first direction.

In another embodiment, an appliance is provided. The appliance includes a housing, and a duct assembly for flowing a fluid therethrough. The duct assembly includes a plurality of conduits connected together to define a flowpath for fluid therethrough. At least one of the plurality of conduits includes a body having an inner surface and an outer surface, the inner surface defining an interior. The at least one of the plurality of conduits further includes a flow regulation assembly disposed within the interior. The flow regulation assembly includes an integral component that is monolithic with the body. The flow regulation assembly is configured to permit fluid flow through the interior past the flow regulation assembly in a first direction and restrict fluid flow through the interior past the flow regulation assembly in a second direction opposite to the first direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic diagram of an appliance in accordance with one embodiment of the present disclosure;

FIG. 2 is a side cross-sectional view of a conduit, including an integral, monolithic flow regulation assembly in an open position during flow in a first direction, in accordance with one embodiment of the present disclosure;

FIG. 3 is a side cross-sectional view of the conduit of FIG. 2, including an integral, monolithic flow regulation assembly in a closed position during flow in a second direction;

FIG. 4 is a perspective view of the conduit of FIG. 2, including an integral, monolithic flow regulation assembly in a closed position during flow in a second direction;

FIG. 5 is a side cross-sectional view of a conduit, including an integral, monolithic flow regulation assembly in an open position during flow in a first direction, in accordance with another embodiment of the present disclosure;

FIG. 6 is a side cross-sectional view of the conduit of FIG. 5, including an integral, monolithic flow regulation assembly in a closed position during flow in a second direction;

FIG. 7 is a perspective view of the conduit of FIG. 5, including an integral, monolithic flow regulation assembly in an open position during flow in a first direction;

FIG. 8 is a side cross-sectional view of a conduit, including a flow regulation assembly having integral, monolithic components in an open position during flow in a first direction, in accordance with another embodiment of the present disclosure;

FIG. 9 is a side cross-sectional view of the conduit of FIG. 8, including a flow regulation assembly having integral, monolithic components in a closed position during flow in a second direction;

FIG. 10 is a cross-sectional view, along the line 10-10 of FIG. 8, of a conduit, including a flow regulation assembly having integral, monolithic components; and

FIG. 11 is a side cross-sectional view of a conduit, including multiple integral, monolithic flow regulation assemblies in an open position during flow in a first direction, in accordance with one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

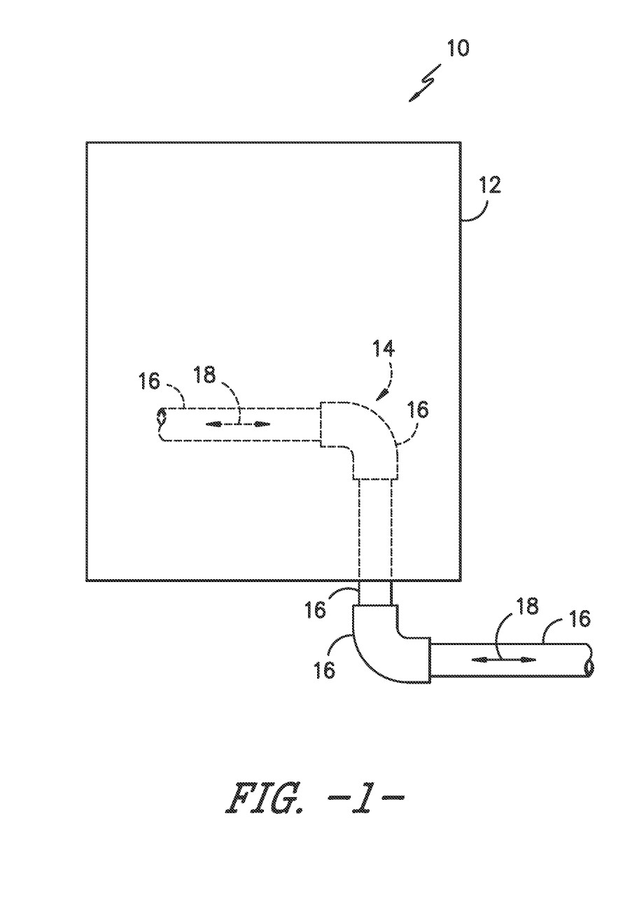

FIG. 1 is a schematic view of an appliance 10. Appliance 10 may be any suitable appliance which utilizes conduits for flowing fluid therefrom, including for example a refrigerator, dishwasher, washing machine, etc. Appliance 10 generally includes a housing 12. Further, appliance 10 may include a duct assembly 14 for flowing a fluid (which may for example be liquid or gas) therethrough. The duct assembly 14 be entirely interior to the housing 12, entirely exterior to the housing 12, or have interior and exterior portions and thus extend through the housing 12. For example, in some embodiments, duct assembly 14 may be an air duct or drain line.

Duct assembly 14 may include a plurality of conduits 16 which may be connected together to define a flowpath 18 for fluid therethrough. The conduits 16 may be directly connected, such as for example via male and female features of the neighboring ends of the conduits 16. Conduits in accordance with the present disclosure include, for example, pipe sections (as shown) as well as connector components such as elbows (as shown), flanges, traps, couplings, etc.

As discussed further in detail herein, at least one of the plurality of conduits 16 may include one or more flow regulation assemblies. Each flow regulation assembly may permit flow in one direction through the conduit and past the flow regulation assembly, and restrict flow in an opposite direction through the conduit and past the flow regulation assembly. Accordingly, flow regulation within the conduits 16 and duct assemblies 14 generally may advantageously be provided.

Further, flow regulation assemblies in accordance with the present disclosure are wholly or partially integral and monolithic with the body of the associated conduit 16, and disposed entirely within the interior of the associated conduit 16. The monolithic construction of a conduit such that the body and one or more components of an associated flow regulation assembly are formed as a single component advantageously increases the strength of the resulting conduit relative to previously known conduit assemblies having separate valves for flow regulation, because weak spots at the valve-conduit joints are eliminated. Further, the positioning of the flow regulation assemblies entirely within the interiors of the conduits advantageously increases potential options for positioning of the flow regulation assemblies, in particular in complex conduit structures such as for example, the structure illustrated in FIG. 11.

The construction of conduits 16 in accordance with the present disclosure, having flow regulation assemblies with components which are integral and monolithic with the associated bodies, has previously not been possible due to manufacturing restraints. However, the present inventors have advantageously utilized current advances in additive manufacturing techniques to develop exemplary embodiments of such conduits 16 in accordance with the present disclosure. While the present disclosure is not limited to the use of additive manufacturing to form such conduits 16, additive manufacturing does provide a variety of manufacturing advantages, including ease of manufacturing, reduced cost, greater accuracy, etc.

As used herein, the terms “additively manufactured” or “additive manufacturing techniques or processes” refer generally to manufacturing processes wherein successive layers of material(s) are provided on each other to “build-up”, layer-by-layer, a three-dimensional component. The successive layers generally fuse together such as that a monolithic component is formed which may have a variety of integral sub-components. Suitable additive manufacturing techniques in accordance with the present disclosure include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM) and Direct Metal Deposition (DMD).

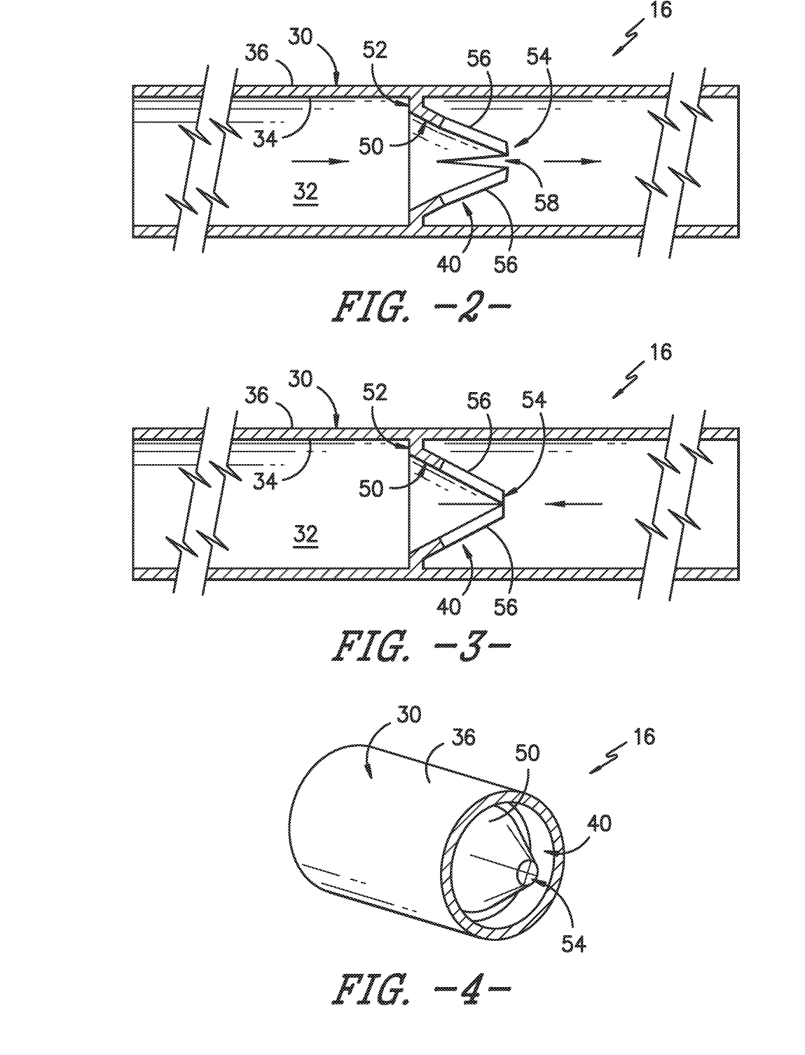

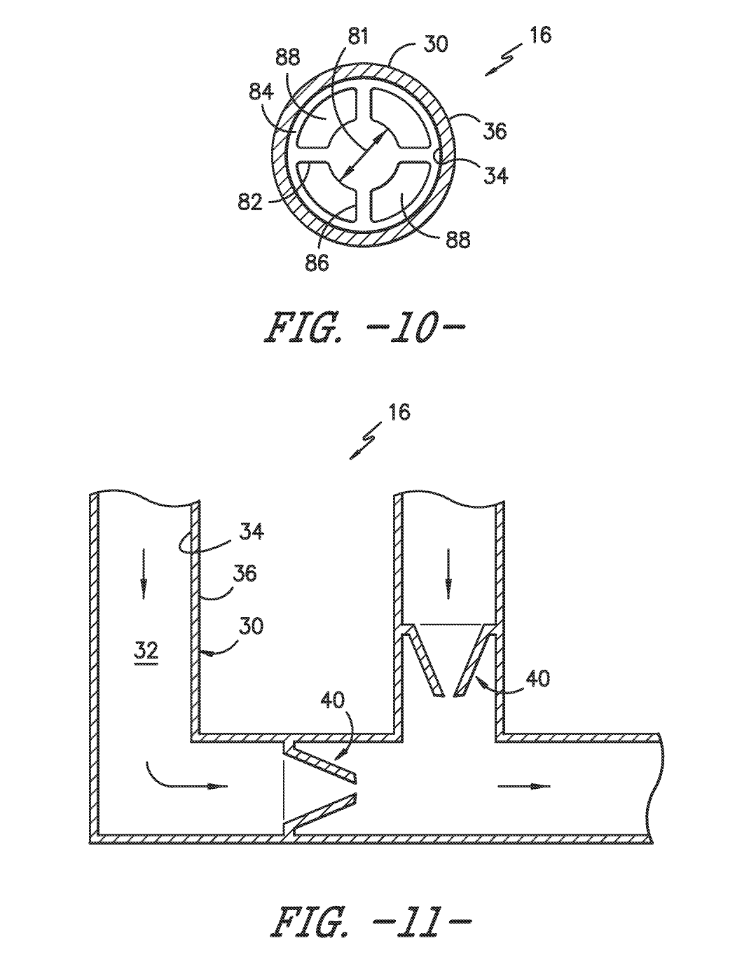

Referring now to FIGS. 2 through 11, various embodiments of a conduit 16 in accordance with the present disclosure are illustrated. A conduit 16 includes a body 30 which defines an interior 32. Body 30 has an inner surface 34, which defines the interior 32, and an opposing outer surface 36. In some embodiments, as illustrated, body 30 may have a generally cylindrical shape. In other embodiments, body 30 may have any other suitable hollow polygonal shape. Further, body 30 may extend generally linearly, as shown in FIGS. 2 through 10, or generally curvilinearly, or may have various linear and curvilinear portions extending in various directions. For example, FIG. 11 illustrates a cylindrical body with a number of linear portions having a complex shape.

As further illustrated in FIGS. 2 through 11, conduit 16 further includes one or more flow regulation assemblies 40. Each flow regulation assembly 40 is disposed within the interior 32 of the conduit 16. A flow regulation assembly 40 in accordance with the present disclosure may be configured to permit fluid flow through the interior 32 past the flow regulation assembly 40 in a first direction, as illustrated for example, in FIGS. 2, 5, 7, 8 and 11. A flow regulation assembly 40 in accordance with the present disclosure may further be configured to restrict fluid flow through the interior 32 past the flow regulation assembly 40 in a second direction opposite to the first direction, as illustrated in FIGS. 3, 4, 6 and 9. The first and second directions of fluid flow are illustrated by arrows in the various Figures as described.

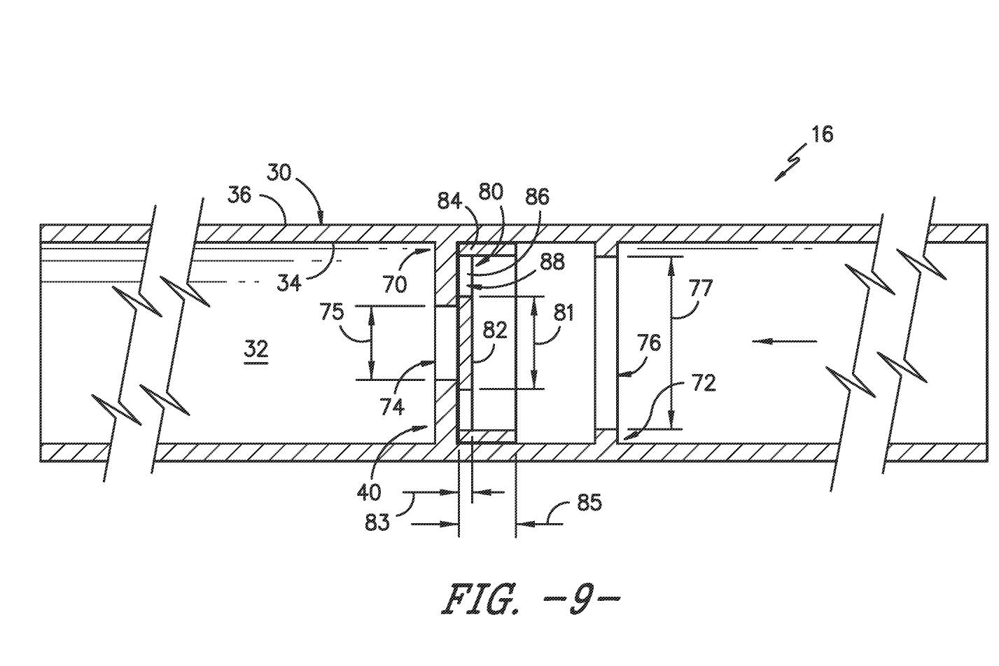

Further, a flow regulation assembly 40 in accordance with the present disclosure includes one or more integral components which are monolithic with the body 30. Accordingly, these components are connected to the body 16, and the body 30 and these components are formed as a single, unitary component such as via additive manufacturing. In some embodiments as illustrated in FIGS. 2 through 7 and 11, the entire flow regulation assembly 40, and thus all components thereof, are integral and monolithic with the body 30. In other embodiments, as illustrated in FIGS. 8 through 10, certain components of the flow regulation assembly 40 are integral and monolithic with the body 30. In these embodiments, the flow regulation assembly 40 may further include one or more non-integral components which generally free from the body 30 and translatable within the interior 32.

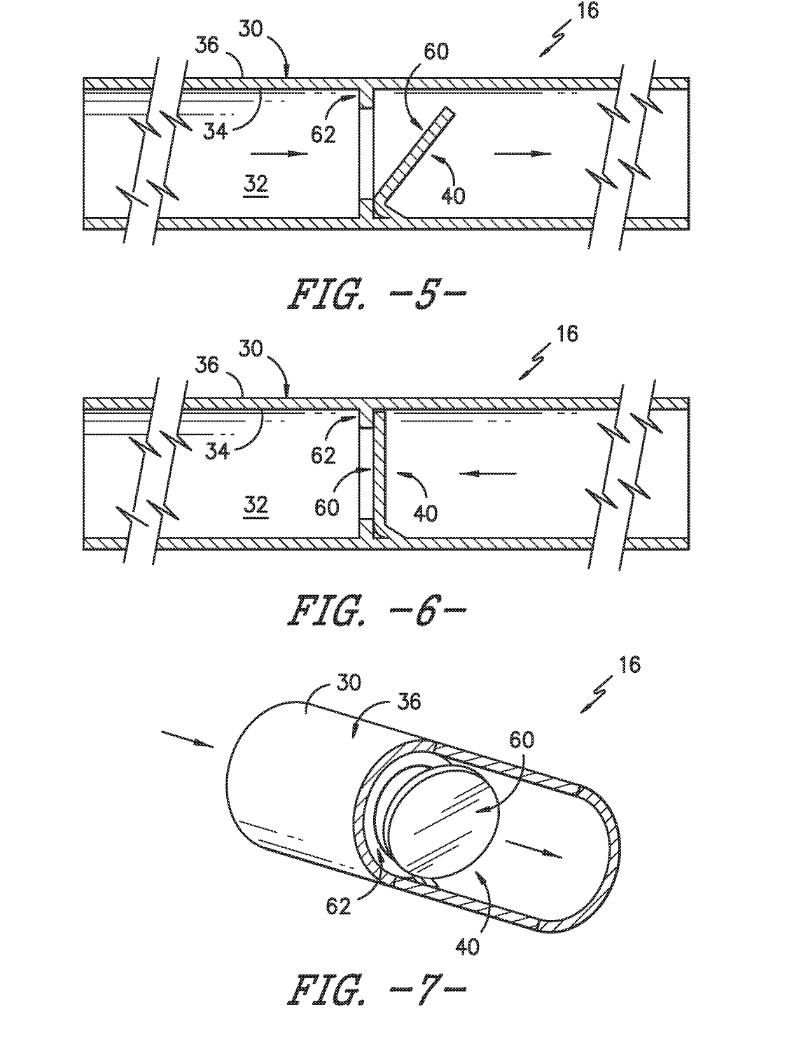

Referring now to FIGS. 2 through 4 as well as FIG. 11, one embodiment of a flow regulation assembly 40 is illustrated. In these embodiments, flow regulation assembly 40 includes a tube 50 which is integral and monolithic with the body 30. The tube 50 may extend between a first end 52 and a second end 54, and may taper towards the second end 54 as shown. First end 52 may extend from the inner surface 34 as illustrated, and the second end 54 may be generally cantilevered within the interior 32. As illustrated, the second end 54 may be adjustable between an open position (see FIGS. 2 and 11) wherein fluid flow through the interior 32 past the flow regulation assembly 40 is permitted and a closed position (see FIGS. 3 and 4) wherein fluid flow through the interior 32 past the flow regulation assembly 40 is restricted.

For example, as shown, a portion of the tube 50 including the second end 54 may be divided into a plurality of tube sections 56 which may be pivotable relative to each other and the remainder of the tube 50. When fluid is flowing in the first direction, the force of the fluid on the tube sections 56 may cause them to pivot apart, such that an aperture 58 is defined in the second end 54 for fluid flow therethrough. When fluid is flowing in the second direction, the force of the fluid on the tube sections 56 may cause them to pivot together, generally eliminating the aperture 58 such that fluid flow through the second end 54 is restricted.

Referring now to FIGS. 5 through 7, another embodiment of a flow regulation assembly 40 is illustrated. In these embodiments, flow regulation assembly 40 includes a plate 60 that is integral and monolithic with the body 30. A portion of the edge of the plate 60 may, for example, extend from the inner surface 34. Plate 60 may, for example, have a shape that generally confirms to the cross-sectional shape of the interior 32.

In some embodiments, flow regulation assembly 40 may further include a tab 62 that is integral and monolithic with the body 30. Tab 62 may extend from the inner surface 34. The tab 62 may in some embodiments extend perimetrically about the entire inner surface 34, as partially illustrated in FIG. 7. In alternative embodiments, tab 62 may extend perimetrically about only a portion of the inner surface 34.

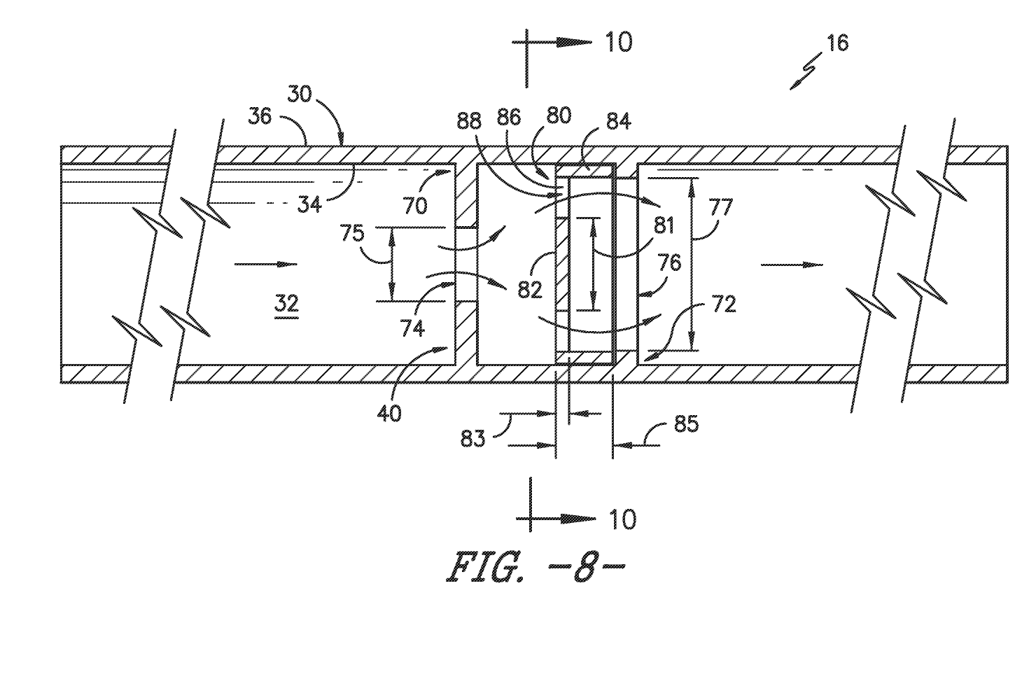

The plate 60 may be pivotable between an open position (see FIGS. 5 and 7) wherein fluid flow through the interior 32 past the flow regulation assembly 40 is permitted and a closed position (see FIG. 6) wherein fluid flow through the interior 32 past the flow regulation assembly 40 is restricted. For example, when fluid is flowing in the first direction, the force of the fluid on the plate 60 may cause it to pivot to a position such that fluid can flow through the interior 32 past the plate 60. When fluid is flowing in the second direction, the force of the fluid on the plate 60 may cause it to pivot to a position such that fluid flow through the interior 32 past the plate 60 is generally prevented. When in the closed position due to fluid flow in the second direction, the plate 60 may contact and seat against the tab 62 to restrict fluid flow therepast as shown and/or may contact and seat against the inner surface 34 to restrict fluid flow therepast.

Referring now to FIGS. 8 through 10, another embodiment of a flow regulation assembly 40 is illustrated. In these embodiments, flow regulation assembly 40 includes a first tab 70 and a second tab 72, each of which are integral and monolithic with the body 30. The tabs 70, 72 may be spaced apart from each other within the interior 32, such as along the first and second flow directions through the interior 32. Tabs 70, 72 may each extend from the inner surface 34. Further, each tab 70, 72 may extend perimetrically about the entire inner surface 34. Accordingly, tab 70 may define a first bore 74 therethrough, and tab 72 may define a second bore 72 therethrough. As illustrated, first bore 74 may have a maximum width 75 (which may for example be a diameter) that is less than a maximum width 77 (which may for example be a diameter) of the second bore 72.

In these embodiments, flow regulation assembly 40 may further include a disk 80, which may be disposed between the first tab 70 and second tab 72. While disk 80 may be formed with conduit 16 such as through additive manufacturing, disk 80 is not integral and monolithic with body 30. Rather, disk 80 may be translatable within interior 32, such as between the first tab 70 and second tab 72. Disk 80 may be configured to permit fluid flow therepast when in contact with and seated against the second tab 72, such that the fluid flows through the larger second bore 76, and further configured to restrict fluid flow therepast when in contact with and seated against the first tab 70, such that fluid flow through the smaller first bore 74 is generally prevented. Accordingly, and further, disk 80 may thus be translatable between an open position (as illustrated in FIG. 8) seated against the second tab 72 wherein fluid flow through the interior 32 past the flow regulation assembly 40 is permitted and a closed position (as illustrated in FIG. 9) seated against the first tab 70 wherein fluid flow through the interior 32 past the flow regulation assembly 40 is restricted.

For example, disk 80 may include an inner plate 82, an outer ring 84, and a plurality of arms 86 extending between the inner plate 82 and outer ring 84. Apertures 88 may be defined between the arms 86 through which fluid may flow. As illustrated, disk 80 may have a maximum width 81 (which may for example be a diameter) that is greater than the maximum width 75 and less than the maximum width 77. Further, disk 80 may have a surface area that is greater than the surface area of bore 74 and less than the surface area of bore 76, and may have a shape that corresponds to the shapes of the bores 74, 76. Accordingly, when the disk 80 is in the open position, the size differential between the larger bore 76 and smaller plate 82 may allow flow past the plate 82, through the apertures 88 and through the bore 76. When the disk 80 is in the closed position, the size differential between the smaller bore 74 and larger plate 82 may allow the plate 82 to generally block flow through the bore 74.

Additionally, in some embodiments, a maximum length 85 of the outer ring 84 may be greater than the maximum length 83 of the inner plate 82. This excess length 85 may be positioned such that, when the disk 80 is in the open position as illustrated in FIG. 8, the outer ring 84 may contact the tab 72 but the inner plate 82 may be spaced from the tab 72 and bore 76. This may further facilitate flow past the disk 80 and through the bore 76. When the disk 80 is in the closed position as illustrated in FIG. 9, the inner plate 82 may contact the tab 70, thus generally blocking flow through the bore 74.

As discussed, the body 30 and integral components of the flow regulation assembly 40 may be additively manufactured or otherwise manufactured such that they are monolithic. The body 30 and flow regulation assembly 40 (including the integral components thereof) may in exemplary embodiments be formed from a single material. Alternatively, however different materials may be utilized to form the body 30 and flow regulation assembly 40 (including the integral components thereof). In exemplary embodiments, the body 30 and flow regulation assembly 40 (including the integral components thereof) may be formed from suitable polymers, which may be identical or different. For example, body 30 may be formed from a rigid polymer, such as acrylonitrile butadiene styrene, polypropylene, polycarbonate. Components of the flow regulation assembly 40, such as the integral components thereof, may be formed from a flexible polymer, such as a thermoplastic elastomer. In other embodiment, the body 30 and flow regulation assembly 40 (including the integral components thereof) may be formed from suitable metals or any other suitable materials, which may be identical or different.

Still further, in some embodiments, the hardness (which may for example be measured as a durometer or using any other suitable hardness scale) of material utilized for the integral components of the flow regulation assembly 40 may be different from the hardness of the body 30. For example, in exemplary embodiments, the hardness of the integral components may be less than the hardness of the body 30. In alternative embodiments, the hardness of the integral components may be greater than the hardness of the body 30. Of course, in still further alternative embodiments, the hardness of the integral components may be equal to the hardness of the body 30.

In exemplary embodiments, the difference in materials and hardness may provide the required rigidity to the body 30 while allowing various integral components of the flow regulation assembly 40 to, while being monolithic with the body 30, be flexible and thus adjustable, pivotable, etc. within the body 30. This may advantageously facilitate the improved flow modification features as discussed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A conduit, comprising:
a body having an inner surface and an outer surface, the inner surface defining an interior; and
a flow regulation assembly disposed within the interior, the flow regulation assembly comprising an integral component that is monolithic with the body, the flow regulation assembly configured to permit fluid flow through the interior past the flow regulation assembly in a first direction and restrict fluid flow through the interior past the flow regulation assembly in a second direction opposite to the first direction.

2. The conduit of claim 1, wherein the entire flow regulation assembly is integral and monolithic with the body.

3. The conduit of claim 1, wherein the flow regulation assembly further comprises a non-integral component that is translatable within the interior.

4. The conduit of claim 1, wherein the integral component is a plurality of integral components, each of the plurality of integral components monolithic with the body.

5. The conduit of claim 1, wherein the flow regulation assembly comprises a tube integral and monolithic with the body, the tube extending between a first end and a second end, the tube tapering towards the second end, the second end adjustable between an open position wherein fluid flow through the interior past the flow regulation assembly is permitted and a closed position wherein fluid flow through the interior past the flow regulation assembly is restricted.

6. The conduit of claim 1, wherein the flow regulation assembly comprises a plate that is integral and monolithic with the body, the plate pivotable between an open position wherein fluid flow through the interior past the flow regulation assembly is permitted and a closed position wherein fluid flow through the interior past the flow regulation assembly is restricted.

7. The conduit of claim 6, wherein the flow regulation assembly further comprises a tab that is integral and monolithic with the body.

8. The conduit of claim 1, wherein the flow regulation assembly comprises a first tab and a second tab each integral and monolithic with the body, the first tab and second tab spaced apart within the interior, the first tab and second tab each extending perimetrically about the inner surface and defining a first bore and a second bore respectively therethrough, the first bore having a maximum width less than a maximum width of the second bore.

9. The conduit of claim 8, wherein the flow regulation assembly further comprises a disk disposed between the first tab and the second tab, the disk comprising an inner plate, an outer ring, and a plurality of arms extending between the inner plate and the outer ring, the disk translatable between an open position seated against the second tab wherein fluid flow through the interior past the flow regulation assembly is permitted and a closed position seated against the first tab wherein fluid flow through the interior past the flow regulation assembly is restricted.

10. The conduit of claim 1, wherein the body and integral component are additively manufactured.

11. The conduit of claim 1, wherein the body is generally cylindrical.

12. The conduit of claim 1, wherein the body and the flow regulation assembly are formed from polymers.

13. The conduit of claim 1, wherein a hardness of the integral component is less than a hardness of the body.

14. An appliance, comprising:
a housing; and
a duct assembly for flowing a fluid therethrough, the duct assembly comprising a plurality of conduits connected together to define a flowpath for fluid therethrough, at least one of the plurality of conduits comprising:
a body having an inner surface and an outer surface, the inner surface defining an interior; and
a flow regulation assembly disposed within the interior, the flow regulation assembly comprising an integral component that is monolithic with the body, the flow regulation assembly configured to permit fluid flow through the interior past the flow regulation assembly in a first direction and restrict fluid flow through the interior past the flow regulation assembly in a second direction opposite to the first direction.

15. The appliance of claim 14, wherein the entire flow regulation assembly is integral and monolithic with the body.

16. The appliance of claim 14, wherein the flow regulation assembly further comprises a non-integral component that is translatable within the interior.

17. The appliance of claim 14, wherein the integral component is a plurality of integral components, each of the plurality of integral components monolithic with the body.

18. The appliance of claim 14, wherein the body and integral component are additively manufactured.

19. The appliance of claim 14, wherein the body and the flow regulation assembly are formed from polymers.

20. The appliance of claim 14, wherein a hardness of the integral component is less than a hardness of the body.
